(19) United States
(12) Patent Application Publication
(10) Pub. No.: US 2019/0158909 A1
(43) Pub. Date: May 23, 2019

(54) EXTENDING SYNCHRONOUS MEDIA PLAYBACK TO A BLUETOOTH-ONLY SINK DEVICE IN A CONNECTED MEDIA ENVIRONMENT

(71) Applicant: QUALCOMM Incorporated, San Diego, CA (US)

(72) Inventors: Shrinivas KULKARNI, Bangalore (IN); Girish SADANANDA, Shimoga District (IN); Kesava Guptha MURALIDHARAN, Bangalore (IN)

(21) Appl. No.: 15/817,120

(22) Filed: Nov. 17, 2017

(51) Int. Cl. H04N 21/43; H04N 21/436

(52) U.S. Cl. CPC H04N 21/4302; H04W 84/12; H04N 21/43615

(57) ABSTRACT

To enable synchronous media playback in a connected media environment, a source device may calculate a presentation time stamp (PTS) value defining a playback time for media packets to be streamed via a wireless local area network (WLAN) link. The source device may then recalculate the PTS value based on a time delay associated with a wireless personal area network (WPAN) link. As such, the source device may transmit the media packets with the recalculated PTS value to a first sink device via the WLAN link and further transmit the media packets to a second sink device via the WPAN link at a time prior to the recalculated PTS value (based on the time delay associated with the WPAN link) such that the first sink device and the second sink device render the media packets at substantially the same time.

### TECHNICAL FIELD

The various aspects and embodiments described herein relate to extending synchronous media playback to a Bluetooth-only sink device in a connected media environment that further includes one or more sink devices with capabilities to receive and render media content transmitted via a wireless local area network (WLAN) link.

### BACKGROUND

Wireless networking can now advantageously provide the wireless distribution of entertainment streaming media to consumers. For example, there are several known multi-room streaming solutions that permit a user to stream a local audio and/or video source to multiple output devices in sync using an IEEE 802.11b-based wireless network (commonly referred to as “Wi-Fi”). For example, certain existing media streaming technologies may enable use cases in which a small form factor device (or puck) may support Wi-Fi and Bluetooth technologies and push an audio stream to one or more wireless speakers and/or other audio devices via a wireless local area network (WLAN) link. The wireless speakers and the puck may support synchronous playback through time-synchronization, which a master device may calibrate via publishing a presentation time stamp (PTS) on each audio packet transmitted via the WLAN link. Accordingly, each Wi-Fi sink device (e.g., audio speakers, headset, etc.) that can receive the media stream via the WLAN link may play the corresponding packet at the time indicated in the presentation time stamp to stay in sync with the master device. However, Bluetooth technology does not presently support PTS-based playback, which may lead to synchronization issues when the media stream is routed to a Bluetooth-only sink device. Nonetheless, there remains a strong consumer demand for Bluetooth-only devices (e.g., speakers, headsets, etc.) because many such devices are already available on the market, often at a lower cost than Wi-Fi speakers. There is therefore a need to enable seamless synchronous media playback in a content ecosystem that includes one or more Bluetooth-only sinks deployed in combination with one or more Wi-Fi sinks.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, to enable synchronous media playback in a connected media environment, a source device may calculate a presentation time stamp (PTS) value defining a playback time for media packets to be streamed via a wireless local area network (WLAN) link. The source device may then recalculate the PTS value based on a time delay associated with a wireless personal area network (WPAN) link. As such, the source device may transmit the media packets with the recalculated PTS value to a first sink device via the WLAN link and further transmit the media packets to a second sink device via the WPAN link at a time prior to the recalculated PTS value (based on the time delay associated with the WPAN link) such that the first sink device and the second sink device render the media packets at substantially the same time.

According to various aspects, a method for enabling synchronous media playback in a connected media environment may therefore comprise calculating, at a source device, a PTS value indicating a local playback time for one or more media packets that the source device is configured to stream to a first sink device via a WLAN link, receiving, at the source device, a delay report from a second sink device, the delay report indicating a time delay associated with a WPAN link between the source device and the second sink device, recalculating, at the source device, the PTS value based on the time delay indicated in the delay report received from the second sink device, transmitting, by the source device, the one or more media packets to the first sink device via the WLAN link, wherein the one or more media packets transmitted via the WLAN link include the recalculated PTS value, and transmitting, by the source device, the one or more media packets to the second sink device via the WPAN link, wherein the one or more media packets are transmitted via the WPAN link at a time prior to the recalculated PTS value based on the time delay indicated in the delay report received from the second sink device.

According to various aspects, an apparatus as described herein may comprise one or more processors configured to calculate an initial PTS value indicating a local playback time for one or more media packets to be streamed to a first sink device via a WLAN link, a receiver configured to receive a delay report from a second sink device, the delay report including a time delay associated with a WPAN link between the apparatus and the second sink device, and a transmitter configured to transmit the one or more media packets to the first sink device via the WLAN link, wherein the one or more media packets transmitted via the WLAN link include a recalculated PTS value based on the initial PTS value and the time delay indicated in the delay report received from the second sink device, and to transmit the one or more media packets to the second sink device via the WPAN link, wherein the one or more media packets are transmitted via the WPAN link at a time prior to the recalculated PTS value based on the time delay indicated in the delay report received from the second sink device.

According to various aspects, an apparatus as described herein may comprise means for calculating a PTS value indicating a local playback time for one or more media packets to be streamed to a first sink device via a WLAN link, means for receiving a delay report from a second sink device, the delay report indicating a time delay associated with a WPAN link between the apparatus and the second sink device, means for recalculating the PTS value based on the time delay indicated in the delay report received from the second sink device, means for transmitting the one or more media packets to the first sink device via the WLAN link, wherein the one or more media packets transmitted via the WLAN link include the recalculated PTS value, and means for transmitting the one or more media packets to the second sink device via the WPAN link, wherein the one or more media packets are transmitted via the WPAN link at a time prior to the recalculated PTS value based on the time delay indicated in the delay report received from the second sink device.

According to various aspects, a computer-readable storage medium as described herein may have computer-executable instructions stored thereon, the computer-executable instructions configured to cause a source device to calculate a PTS value indicating a local playback time for one or more media packets to be streamed to a first sink device via a WLAN link, receive a delay report from a second sink device, the delay report indicating a time delay associated with a WPAN link between the source device and the second sink device, recalculate the PTS value based on the time delay indicated in the delay report received from the second sink device, transmit the one or more media packets to the first sink device via the WLAN link, wherein the one or more media packets transmitted via the WLAN link include the recalculated PTS value, and transmit the one or more media packets to the second sink device via the WPAN link, wherein the one or more media packets are transmitted via the WPAN link at a time prior to the recalculated PTS value based on the time delay indicated in the delay report received from the second sink device.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary system for outputting synchronized media content in a network environment, according to various aspects.

FIG. 2 illustrates an exemplary communication flow that may enable synchronous media playback at a master device and one or more slave devices that communicate via a WLAN link, according to various aspects.

FIG. 3 illustrates an exemplary method for extending the synchronous media playback as shown in FIG. 2 to one or more Bluetooth-only sink devices, according to various aspects.

FIG. 4 illustrates an exemplary communication flow that may be used to extend synchronous media playback to one or more Bluetooth-only sink devices in a connected environment that further includes one or more sink devices that communicate with a master device via a WLAN link, according to various aspects.

FIG. 5 illustrates an exemplary electronic device that may be configured in accordance with the various aspects and embodiments described herein.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

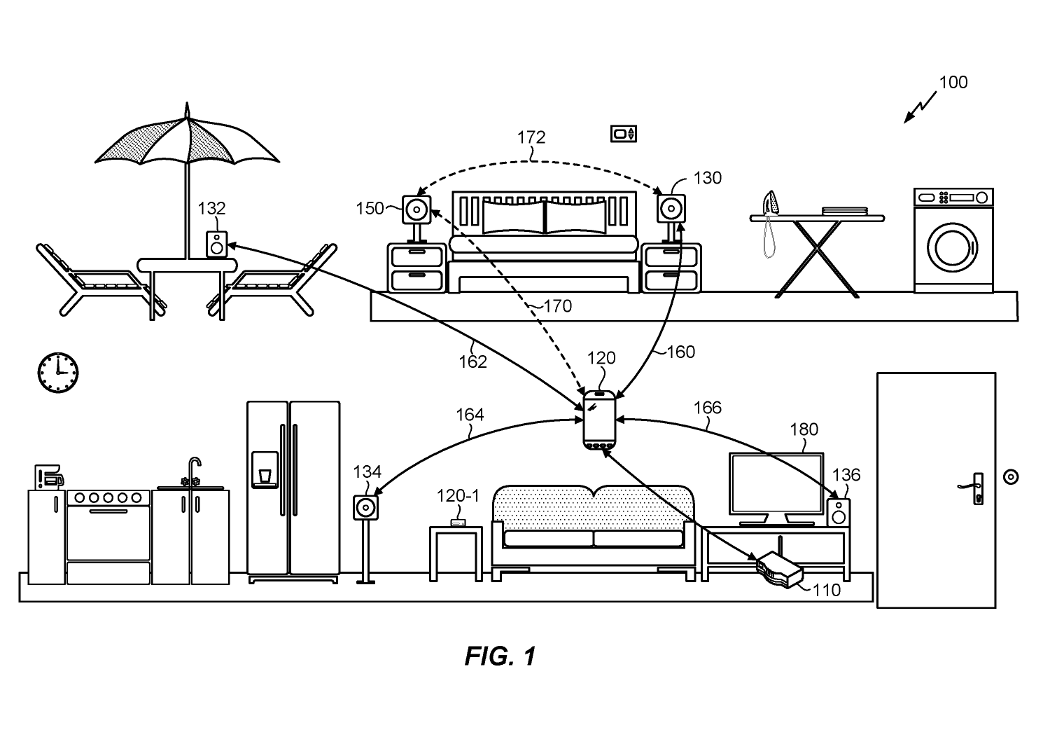

According to various aspects, FIG. 1 illustrates an exemplary system 100 for outputting synchronized media content in a network environment. In the example shown in FIG. 1, the system 100 includes a master output device 120 that can transmit a media stream to various slave output devices 130, 132, 134, 136, 150, wherein the master output device 120 may alternatively be referred to as a source device, a controller device, and/or other suitable terminology while the slave output devices 130, 132, 134, 136, 150 may alternatively be referred to as sink devices and/or other suitable terminology. Additionally, in various embodiments, the master output device 120 may include or function as a human interface device (e.g., a smartphone, tablet or hybrid device, wearable computing device, etc.) that can receive user inputs and control other devices in the system 100 in addition to outputting the media stream in synchronization with the slave output devices 130, 132, 134, 136, 150, etc. Alternatively and/or additionally, in various embodiments, the system 100 may include a streaming device 120-1 (e.g., a small form factor device or “puck”) that can transmit the media stream to the master output device 120 and/or to the various slave output devices 130, 132, 134, 136, 150, in which case the master output device 120 may function as the human interface device to control the streaming device 120-1 and/or output the media stream via one or more local speakers, displays, or other suitable interfaces.

According to various aspects, the example system 100 is shown in FIG. 1 as being implemented in a local network having a wireless access point 110. Accordingly, in various embodiments, the master output device 120 and the various slave output devices 130, 132, 134, 136, 150 (and the streaming device 120-1 if present) can be directly connected via one or more wireless peer-to-peer connections or indirectly connected via one or more wireless and/or wired connections to the wireless access point 110. For example, as will be described in further detail below, the various aspects and embodiments described herein contemplate that the slave output devices 130, 132, 134, 136 are connected on the wireless network through use of one or more wireless local area network (WLAN) links 160, 162, 164, 166, which may be implemented according to any one or more of the IEEE 802.11 standards (e.g., IEEE 802.11(a), 802.11(b), 802.11(g), 802.11(n), etc., commonly referred to as “Wi-Fi”). Furthermore, in various implementations, some or all of the slave output devices 130, 132, 134, 136 may be capable of peer-to-peer WLAN communications, such as provided by Wi-Fi Direct, and/or wireless personal area network (WPAN) communications, which may be implemented according to any one or more of the IEEE 802.15 standard and/or specifications that are published and managed by the Bluetooth Special Interest Group. Still further, the various aspects and embodiments described herein contemplate that the system 100 includes one or more slave output devices, including at least slave output device 150, that only has capabilities to communicate on the wireless network through use of one or more WPAN links 170, 172 (e.g., Bluetooth links), whereby the slave output device 150 may be conveniently referred to herein as “Bluetooth-only” slave output device 150. As will be described in further detail below, the system 100 may be configured to enable synchronous media playback at the master output device 120, the slave output devices 130, 132, 134, 136 that can receive and render the media stream via the WLAN links 160, 162, 164, 166, and the Bluetooth-only slave output device 150 that can receive and render the media stream via the WPAN links 170, 172.

For example, in various embodiments, the synchronous media playback may be achieved in the system 100 via an application framework or protocol in which individual output devices are aware of one another and have the ability to communicate with one another using appropriate wireless technology, either alone or in combination with wired technology such as Ethernet. In some variations, the application framework or protocol may further provide the output devices with the ability to be aware of each other's capabilities or functionalities, connectivity status, and/or availabilities. Additionally, when functioning as a human interface device, the master output device 120 may communicate with the slave output devices 130, 132, 134, 136, 150 and further determine and be aware of the capability, functionality, connectivity status, and/or availability associated with each of the slave output devices 130, 132, 134, 136, 150.

According to various embodiments, the master output device 120 and the slave output devices 130, 132, 134, 136, 150 may be configured as wireless speakers that can output audio content. In variations, the master output device 120 and the slave output devices 130, 132, 134, 136, 150 may also be configured to output video content. Still further, in various embodiments, the system 100 may include one or more output devices that include a combination of audio output and video output capabilities. For example, in FIG. 1, the system 100 may include a network-enabled television 180 that has a display (video output device) and one or more built-in speakers (audio output devices). Each output device can generate output (audio or video) from a common source. As described by various examples provided below, the master output device 120 and the slave output devices 130, 132, 134, 136, 150 can operate to output content in a connected environment, with the content output being synchronized and continuously corrected to remain synchronized. Additionally, in some embodiments, the system 100 can be implemented with control functionality that monitors for each output device to have a synchronized playback state, as well as sufficient buffering capacity to maintain output without data failure (e.g., sputtering). Throughout the examples provided, the term “media” is intended to refer to either audio or video (or both).

In some embodiments, the master output device 120 can be selected to control media streaming within the system 100 based on various factors, such as capability, protocol, randomness, user or manufacture designation, network performance, one or more static or dynamic factors, or other criteria. In various embodiments, as noted above, the master output device 120 may transmit a media stream to the slave output devices 130, 132, 134, 136 that have WLAN capabilities (hereinafter WLAN slave devices 130, 132, 134, 136) via one or more WLAN links 160, 162, 164, 166 and the master output device 120 may further transmit the media stream to the Bluetooth-only slave output device 150 via a WPAN link 170. In one alternative, the Bluetooth-only slave output device 150 may receive the media stream via a WPAN link 172 with one of the WLAN slave devices (e.g., WLAN slave device 130 in the illustrated example). In any case, the media streamed within the system 100 may be obtained from any one or more of various available sources, which may include internal resources such as memory associated with the master output device 120, external sources such as the streaming device 120-1, a third-party network service (e.g., Internet radio or streaming service, a connected computer or network streaming source, etc.). Accordingly, in various embodiments, the system 100 may be arranged or otherwise configured to render (i.e., output) media at various connected devices using one or more appropriate audio distribution schemes. Furthermore, as will be described in further detail herein, the system 100 may be configured to enable synchronous media playback (i.e., output) at the various connected devices, including the WLAN slave devices 130, 132, 134, 136 and the Bluetooth-only slave device(s) 150.

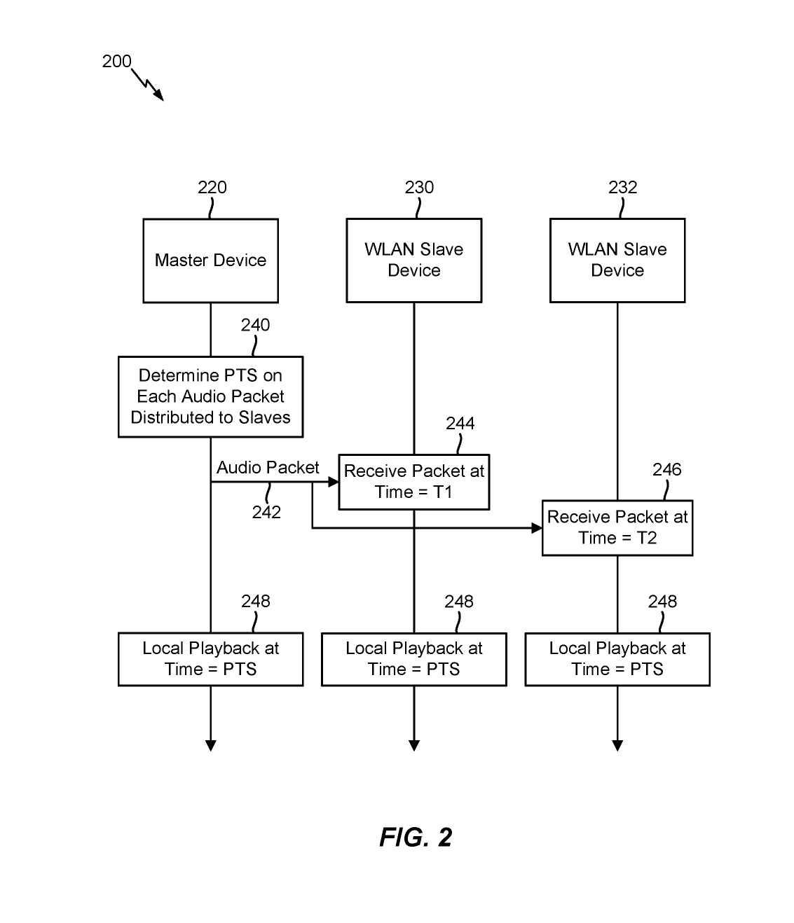

More particularly, according to various aspects, FIG. 2 illustrates an exemplary communication flow 200 that may enable synchronous media playback at a master device 220 and multiple WLAN slave devices 230, 232, wherein the master device 220 may transmit a media stream to the multiple WLAN slave devices 230, 232 via one or more WLAN links. For example, in various embodiments, the communication flow 200 shown in FIG. 2 may be used to maintain synchronicity in timing among the master device 220 and the WLAN slave devices 230, 232, each of which may implement one or more operations to synchronize an internal clock with an external clock reference. In some embodiments, the external clock reference may be provided by the master device 220, another network resource, and/or another suitable source.

With further reference to the example shown in FIG. 2, the master device 220 may be configured to provide the external clock reference by communicating time values to each of the WLAN slave devices 230, 232, wherein the communicated time values enable each of the WLAN slave devices 230, 232 to determine a master or reference clock for synchronization with their respective internal clocks. In various embodiments, at block 240, the master device 220 may determine a presentation time stamp (PTS) to be used on each media packet to be distributed to the WLAN slave devices 230, 232, wherein the PTS may indicate the time when playback is to occur with respect to each individual media packet. Accordingly, when each of the WLAN slave devices 230, 232 are synchronized to the master clock, the PTS provided with each individual media packet ensures that playback of the individual media packets will occur at the master device 220 and the WLAN slave devices 230, 232 at substantially the same time. In this manner, the synchronization to a reference or master clock enables the master device 220 and the WLAN slave devices 230, 232 to collectively maintain the same clock when outputting the media packets in a media stream. For example, as shown in FIG. 2 at 242, the master device 220 may transmit a media packet to the WLAN slave devices 230, 232 via one or more WLAN links. As depicted at 244, 246, the WLAN slave device 230 may receive the media packet at time T1 and the WLAN slave device 232 may receive the media packet at time T2. Even though the WLAN slave devices 230, 232 receive the media packet at different times, the PTS value included with the media packet informs the WLAN slave devices 230, 232 to wait to render the media packet until the appropriate time indicated by the PTS value to render the media packet, whereby local playback occurs at each device at substantially the same time, as depicted at block 248.

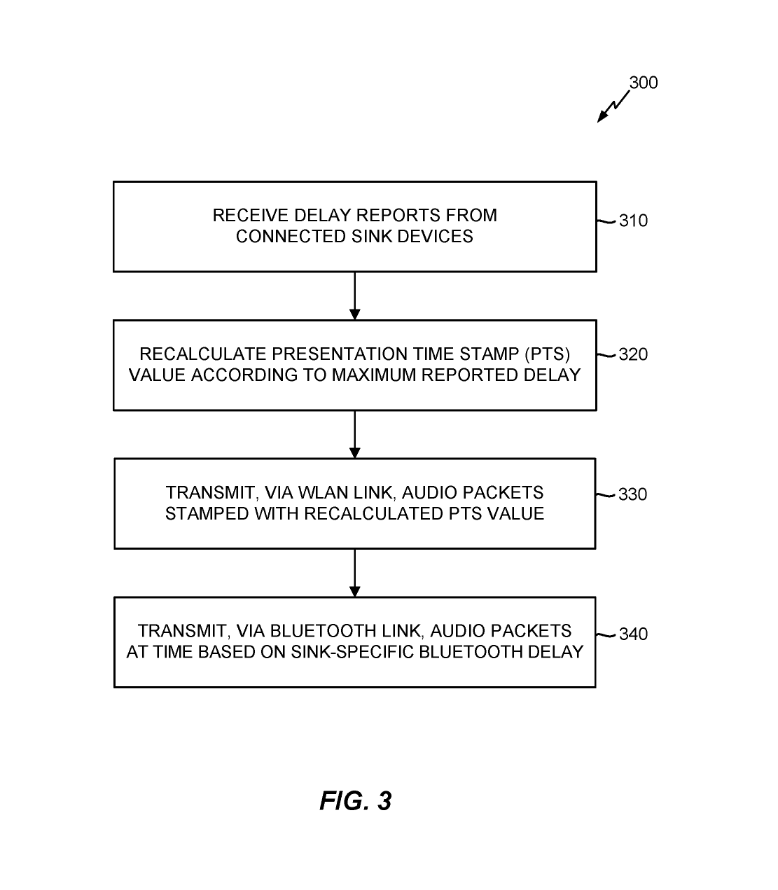

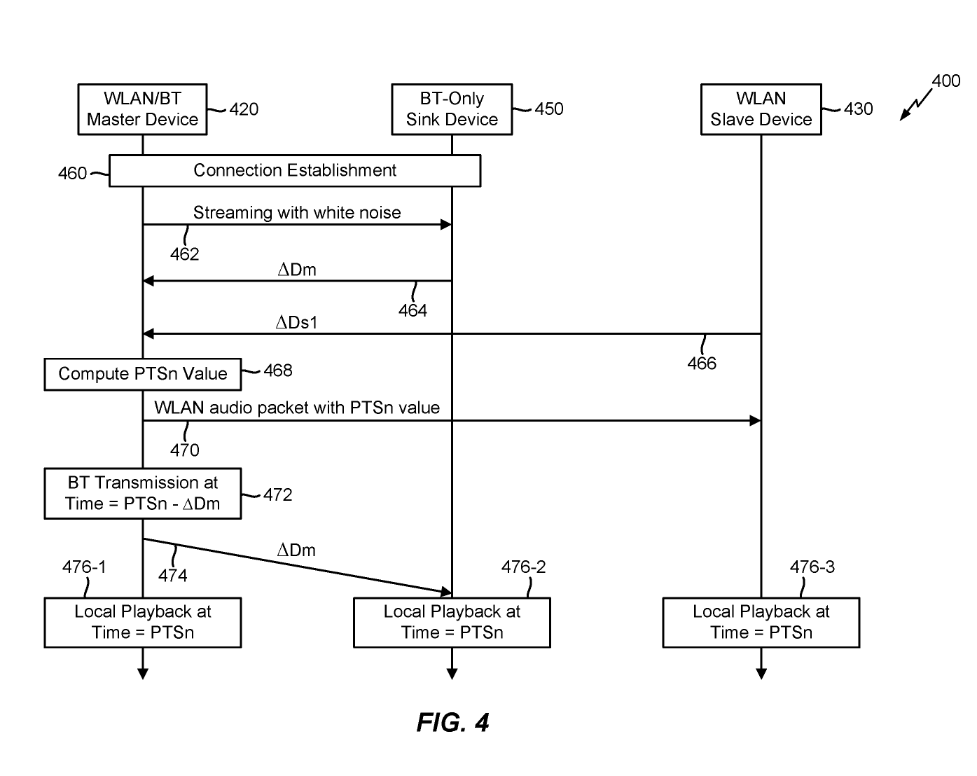

Although including a PTS value in each media packet may time-synchronize playback at various output devices that are connected to one another via one or more WLAN links, output devices that are only configured to communicate according to WPAN standards and/or specifications (e.g., “Bluetooth-only” sink devices) may lack the ability to support PTS-based playback. For example, the PTS included with each media packet may be configured in accordance with a Timing Synchronization Function (TSF) as defined in one or more IEEE 802.11 standards, which may not be supported on Bluetooth-only sink devices. Nonetheless, FIG. 3 and FIG. 4 illustrate exemplary techniques that may be used to extend synchronous playback to one or more Bluetooth-only sink devices in an environment that further includes one or more WLAN slave devices. Accordingly, the following description assumes that a master device streaming media to one or more WLAN slave devices also has the ability to support a source (SRC) role as defined in the Bluetooth specifications for the Advanced Audio Distribution Profile (A2DP) and/or Video Distribution Profile (VDP) and that the Bluetooth-only sink device(s) can support a sink (SNK) role with delay reporting as defined in the Bluetooth A2DP and/or VDP specifications. In particular, the Bluetooth A2DP and/or VDP specifications each define delay reporting procedures to enable synchronized audio and video playback through having a sink device report, to the source device, a time delay caused by buffering, decoding, and rendering. Accordingly, these delay reports can be used to calibrate playback of a Bluetooth stream transmitted to a Bluetooth-only sink device with a media stream transmitted via a WLAN link.

For example, according to various aspects, FIG. 3 illustrates an exemplary method 300 for extending the synchronous media playback as shown in FIG. 2 to one or more Bluetooth-only sink devices. In particular, the method 300 shown in FIG. 3 may assume that a user has selected a media source to be played on a group of media output devices over one or more WLAN links, wherein the primary media source in the group may be designated the master device to enable synchronous playback with the slave devices via the one or more WLAN links. In particular, as mentioned above, the master device may publish a presentation time stamp (PTS) on each media packet transmitted via the WLAN links, and any slave devices receiving the media packet(s) may play the media packet at PTS to ensure synchronous playback with the master device. In general, the master device may have control over the PTS value published with each media packet sent to the slave devices. As such, the initial PTS value may generally include a time delta that is added to each media packet to ensure synchronous playback over the WLAN link(s), which may be designated herein as ΔDw to represent the time delta prior to one or more Bluetooth A2DP and/or VDP connections becoming active.

In various embodiments, at block 310, the master device may connect to one or more Bluetooth-only sink devices (e.g., a Bluetooth-only speaker, headset, etc.) and enable delay reporting during a connection establishment procedure. Accordingly, at block 310, the master device may receive an initial delay report from each Bluetooth device connected to the media ecosystem, wherein the delay reporting procedure may run directly after a stream configuration procedure. Alternatively and/or additionally, the master device may receive subsequent delay reports at block 310, wherein the Bluetooth sink devices may trigger the subsequent delay reports when the delay value has changed to a value that is outside the accuracy range of the previously reported delay, which is generally reported with an accuracy of 0.1 milliseconds (ms). In any case, referring again to FIG. 3, the delay reports may be received at block 310 from each Bluetooth device in the media ecosystem (e.g., ΔDm, ΔDs1, ΔDs2, . . . , ΔDsn from Bluetooth devices respectively connected to the master device, WLAN slave 1, WLAN slave 2, . . . , WLAN slave n). In various embodiments, at block 320, the master device may then recalculate the PTS value to be used on each outgoing packet transmitted via the WLAN link(s) to accommodate the maximum reported Bluetooth delay. For example, at block 320, the master device may add the maximum delay among the Bluetooth delays that are reported at block 310 to the initial PTS value to yield a new PTS value, denoted herein as PTSn. Accordingly, at block 330, the master device may transmit, via the WLAN link, media packets that are stamped with the new PTSn value, whereby any WLAN slave devices will render the media packets at time PTSn. Furthermore, at block 340, the master device may transmit the media packets to each connected Bluetooth device at a particular time that is based on the PTSn value and the sink-specific Bluetooth delay. In particular, at block 340, transmission via the Bluetooth links may occur at time PTSn-ΔDR, where ΔDR is the sink-specific Bluetooth delay as was reported at block 310. As such, the early transmission ensures that the media packet will arrive at the Bluetooth sink(s) at time PTSn, thus containing the sink-specific Bluetooth delay, whereby playback may occur synchronously with any WLAN slave devices that are configured to playback the media packet at time PTSn.

According to various aspects, FIG. 4 illustrates an exemplary communication flow 400 that may be used to extend synchronous media playback throughout a streaming ecosystem in the manner described above. In particular, the communication flow 400 shown in FIG. 4 assumes that the streaming ecosystem includes at least a master device 420 that has capabilities to transmit a media stream via one or more WLAN links and one or more Bluetooth links, a WLAN slave device 430 that can receive and render the media stream via the one or more WLAN links and also has capabilities to report a link-specific delay, and a Bluetooth-only sink device 450. The communication flow 400 shown in FIG. 4 further assumes that the master device 420 has already established a WLAN connection and synchronous playback with the WLAN slave device 430.

Accordingly, as depicted at 460, the master device 420 and the Bluetooth-only sink device 450 may perform a connection establishment procedure in accordance with the Bluetooth A2DP and/or VDP specifications. After the appropriate Bluetooth link has been established, as depicted at 462, the master device 420 may start a media stream with white noise while awaiting a delay report from the connected devices in the streaming ecosystem. For example, as depicted at 464, the master device 420 may receive a delay report from the Bluetooth-only sink device 450 indicating a delay on the Bluetooth link due to buffering, decoding, and rendering, which is represented as ΔDm. Furthermore, as depicted at 466, the master device 420 may receive a delay report from the WLAN slave device 430 indicating a delay between the master device 420 and the WLAN slave device 430, which is represented as ΔDs1. Accordingly, the master device 420 may compute a new presentation time stamp (PTSn) value based on the delays received at 464, 466 (in addition to any delay reports received from other devices that are not shown in FIG. 4 for simplicity and ease of description). In particular, assuming that PTS represents the time delta that the master device 420 used to previously establish synchronous playback with the WLAN slave device 430, the master device 420 may rework the presentation time at 468 such that PTSn=PTS+ΔDp, where ΔDp is the maximum delay received from any connected devices in the streaming ecosystem (i.e., ΔDm and ΔDs1 in the illustrated example). Accordingly, at 470, the master device 420 may transmit a media packet that includes the value for PTSn via the WLAN link such that the master device 420 and the WLAN slave device(s) 430 are configured to perform local playback for the media packet at time PTSn, as depicted at 476-1 and 476-3. Furthermore, at block 472, the master device 420 may configure Bluetooth transmission to occur a certain time prior to PTSn based on the link-specific delay reported from the Bluetooth-only sink device(s) 450. In particular, where FIG. 4 uses the value ΔDm to represent the delay between the master device 420 and the Bluetooth-only sink device 450, Bluetooth transmission may be configured at block 472 to occur at time PTSn-ΔDm. As such, as depicted at 474, ΔDm represents the time needed to transmit, buffer, decode, and render the media packet, whereby transmitting the media packet to the Bluetooth-only sink device 450 at time PTSn-ΔDm ensures that local playback will occur at the Bluetooth-only sink device 450 at time PTSn, as depicted at 476-2 which is time synchronized with the local playback that respectively occurs at the master device 420 and the WLAN slave device 430 at 476-1 and 476-3.

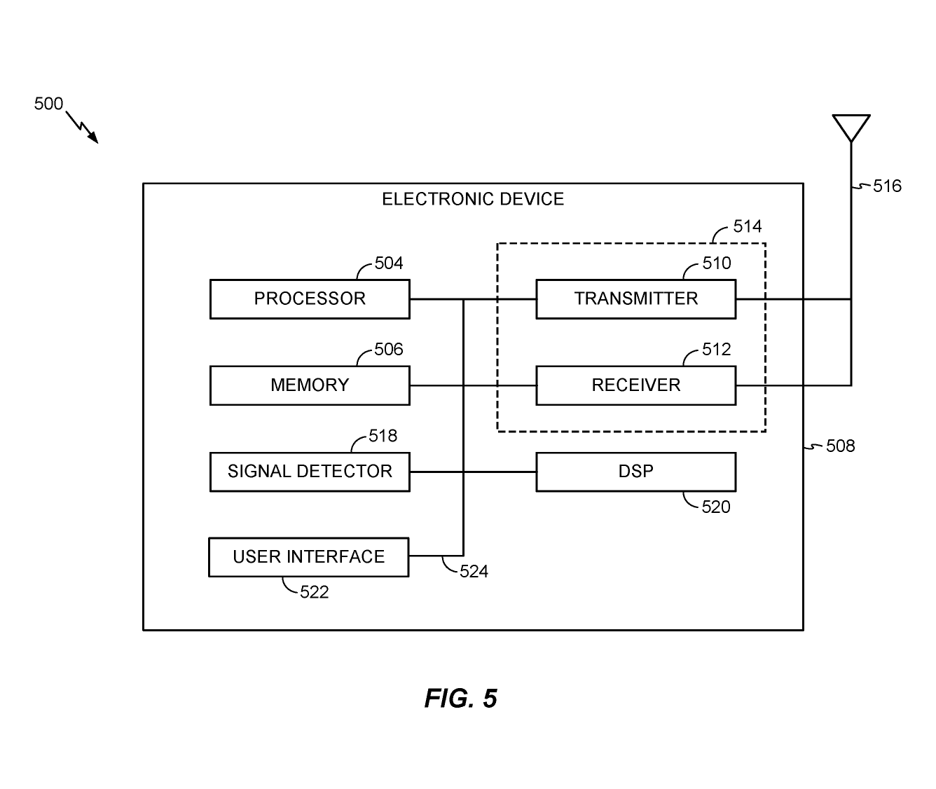

According to various aspects, FIG. 5 illustrates an exemplary electronic device 500 that can be appropriately configured in accordance with the various aspects and embodiments described herein. For example, the electronic device 500 may correspond to a master/source device that can transmit a media stream to at least one slave/sink device via one or more wireless local area network (WLAN) and to at least one slave/sink device via one or more Bluetooth links. Alternatively and/or additionally, the electronic device 500 may correspond to any one or more of a slave/sink device that can receive and render the media stream via the one or more WLAN links, the one or more Bluetooth links, or a combination thereof, a human interface device that can be used to control the master/source device and/or the slave/sink device(s), etc.

In various embodiments, the electronic device 500 can include a processor 504, a memory 506, a housing 508, a transmitter 510, a receiver 512, an antenna 516, a signal detector 518, a digital signal processor (DSP) 520, a user interface 522, and a bus system 524. Alternatively, the functions of the transmitter 510 and the receiver 512 can be incorporated into a transceiver 514. The electronic device 500 can be configured to communicate in a wireless network that includes, for example, a base station (not illustrated), an access point (not illustrated), and the like.

In various embodiments, the processor 504 can be configured to control operations of the electronic device 500. The processor 504 can also be referred to as a central processing unit (CPU). The memory 506 can be coupled to the processor 504, can be in communication with the processor 504, and can provide instructions and data to the processor 504. The processor 504 can perform logical and arithmetic operations based on program instructions stored within the memory 506. The instructions in the memory 506 can be executable to perform one or more of the methods and processes described herein. In various embodiments, the processor 504 can include, or be a component of, a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations and/or manipulate information. The processing system can also include machine-readable media for storing software. Software can be construed broadly to mean any type of instructions, whether referred to as software, firmware, middleware, microcode, hardware description language, or otherwise. Instructions can include code, e.g., in source code format, binary code format, executable code format, or any other suitable format of code. The instructions, when executed by the one or more processors, can cause the processing system to perform one or more of the functions described herein.

In various embodiments, the memory 506 can include both read-only memory (ROM) and random access memory (RAM). A portion of the memory 506 can also include non-volatile random access memory (NVRAM).

In various embodiments, the transmitter 510 and the receiver 512 (or the transceiver 514) can allow transmission and reception of data between the electronic device 500 and a remote location. The antenna 516 can be attached to the housing 508 and electrically coupled to the transceiver 514. In some implementations, the electronic device 500 can also include multiple transmitters, multiple receivers, multiple transceivers, and/or multiple antennas (not illustrated).

In various embodiments, the signal detector 518 can be used to detect and quantify the level of signals received by the transceiver 514. The signal detector 518 can detect such signals as total energy, energy per subcarrier per symbol, and/or power spectral density and in other ways.

In various embodiments, the digital signal processor (DSP) 520 can be used to process signals. The DSP 520 can be configured to generate a packet for transmission. In some aspects, the packet can include a physical layer protocol data unit (PPDU).

In various embodiments, the user interface 522 can include, for example, a keypad, a microphone, a speaker, and/or a display. The user interface 522 can include any element or component that conveys information to a user of the electronic device 500 and/or receives input from a user.

In various embodiments, the various components of the electronic device 500 can be coupled together by a bus system 524. The bus system 524 can include a data bus, and can also include a power bus, a control signal bus, and/or a status signal bus in addition to the data bus.

In various embodiments, the electronic device 500 can also include other components or elements not illustrated in FIG. 5. One or more of the components of the electronic device 500 can be in communication with another one or more components of the electronic device 500 by means of another communication channel (not illustrated) to provide, for example, an input signal to the other component.

Although a number of separate components are illustrated in FIG. 5, one or more of the components can be combined or commonly implemented. For example, the processor 504 and the memory 506 can be embodied on a single chip. The processor 504 can additionally, or in the alternative, contain memory, such as processor registers. Similarly, one or more of the functional blocks or portions of the functionality of various blocks can be embodied on a single chip. Alternatively, the functionality of a particular block can be implemented on two or more chips. For example, the processor 504 can be used to implement not only the functionality described above with respect to the processor 504, but also to implement the functionality described above with respect to the signal detector 518 and/or the DSP 520.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

1. A method for enabling synchronous media playback in a connected media environment, comprising:
calculating, at a source device, a presentation time stamp (PTS) value indicating a local playback time for one or more media packets that the source device is configured to stream to a first sink device via a wireless local area network (WLAN) link;
receiving, at the source device, a delay report from a second sink device, the delay report indicating a time delay associated with a wireless personal area network (WPAN) link between the source device and the second sink device;
recalculating, at the source device, the PTS value based on the time delay indicated in the delay report received from the second sink device;
transmitting, by the source device, the one or more media packets to the first sink device via the WLAN link, wherein the one or more media packets transmitted via the WLAN link include the recalculated PTS value; and
transmitting, by the source device, the one or more media packets to the second sink device via the WPAN link, wherein the one or more media packets are transmitted via the WPAN link at a time prior to the recalculated PTS value based on the time delay indicated in the delay report received from the second sink device.

2. The method recited in claim 1, wherein the one or more media packets are transmitted via the WPAN link at the time based on the time delay indicated in the delay report received from the second sink device such that the second sink device receives and renders the one or more media packets at the recalculated PTS value.

3. The method recited in claim 2, wherein the one or more media packets transmitted via the WLAN link include the recalculated PTS value to inform the first sink device that the local playback time is to occur at the recalculated PTS value.

4. The method recited in claim 3, further comprising outputting, at the source device, the one or more media packets at a time equal to the recalculated PTS value.

5. The method recited in claim 2, wherein the time delay indicated in the delay report received from the second sink device is based on a delay due to buffering, decoding, and rendering at the second sink device.

6. The method recited in claim 1, further comprising:
receiving, at the source device, a delay report from a third sink device, the delay report indicating a time delay associated with a WPAN link between the source device and the third sink device; and
recalculating, at the source device, the PTS value based on a maximum delay among the time delays indicated in the delay reports received from the second sink device and the third sink device.

7. The method recited in claim 1, further comprising:
receiving, at the source device, a subsequent delay report from the second sink device, the subsequent delay report updating the time delay associated with the WPAN link between the source device and the second sink device; and
recalculating, at the source device, the PTS value based on the updated time delay indicated in the subsequent delay report received from the second sink device.

8. The method recited in claim 1, wherein the WPAN link is a Bluetooth link, the one or more media packets comprise audio packets, and the delay report is a Bluetooth Advanced Audio Distribution Profile (A2DP) delay report.

9. The method recited in claim 1, wherein the WPAN link is a Bluetooth link, the one or more media packets comprise video packets, and the delay report is a Bluetooth Video Distribution Profile (VDP) delay report.

10. An apparatus, comprising:
one or more processors configured to calculate an initial presentation time stamp (PTS) value indicating a local playback time for one or more media packets to be streamed to a first sink device via a wireless local area network (WLAN) link;
a receiver configured to receive a delay report from a second sink device, the delay report including a time delay associated with a wireless personal area network (WPAN) link between the apparatus and the second sink device; and
a transmitter configured to:
transmit the one or more media packets to the first sink device via the WLAN link, wherein the one or more media packets transmitted via the WLAN link include a recalculated PTS value based on the initial PTS value and the time delay indicated in the delay report received from the second sink device; and
transmit the one or more media packets to the second sink device via the WPAN link, wherein the one or more media packets are transmitted via the WPAN link at a time prior to the recalculated PTS value based on the time delay indicated in the delay report received from the second sink device.

11. The apparatus recited in claim 10, wherein the one or more media packets are transmitted via the WPAN link at the time based on the time delay indicated in the delay report received from the second sink device such that the second sink device is configured to receive and render the one or more media packets at the recalculated PTS value.

12. The apparatus recited in claim 11, wherein the one or more media packets transmitted via the WLAN link include the recalculated PTS value to inform the first sink device that the local playback time is to occur at the recalculated PTS value.

13. The apparatus recited in claim 12, further comprising an output device configured to output the one or more media packets at a time equal to the recalculated PTS value.

14. The apparatus recited in claim 11, wherein the time delay indicated in the delay report received from the second sink device is based on a delay due to buffering, decoding, and rendering at the second sink device.

15. The apparatus recited in claim 10, wherein the receiver is further configured to receive, from a third sink device, a delay report indicating a time delay associated with a WPAN link between the apparatus and the third sink device, and wherein the one or more processors are further configured to determine the recalculated PTS value based on a maximum delay among the time delays indicated in the delay reports received from the second and third sink devices.

16. The apparatus recited in claim 10, wherein the receiver is further configured to receive, from the second sink device, a subsequent delay report updating the time delay associated with the WPAN link between the apparatus and the second sink device, and wherein the one or more processors are further configured to determine the recalculated PTS value based on the updated time delay indicated in the subsequent delay report.

17. The apparatus recited in claim 10, wherein the WPAN link is a Bluetooth link, the one or more media packets comprise audio packets, and the delay report is a Bluetooth Advanced Audio Distribution Profile (A2DP) delay report.

18. The apparatus recited in claim 10, wherein the WPAN link is a Bluetooth link, the one or more media packets comprise video packets, and the delay report is a Bluetooth Video Distribution Profile (VDP) delay report.

19. An apparatus, comprising:
means for calculating a presentation time stamp (PTS) value indicating a local playback time for one or more media packets to be streamed to a first sink device via a wireless local area network (WLAN) link;
means for receiving a delay report from a second sink device, the delay report indicating a time delay associated with a wireless personal area network (WPAN) link between the apparatus and the second sink device;
means for recalculating the PTS value based on the time delay indicated in the delay report received from the second sink device;
means for transmitting the one or more media packets to the first sink device via the WLAN link, wherein the one or more media packets transmitted via the WLAN link include the recalculated PTS value; and
means for transmitting the one or more media packets to the second sink device via the WPAN link, wherein the one or more media packets are transmitted via the WPAN link at a time prior to the recalculated PTS value based on the time delay indicated in the delay report received from the second sink device.

20. The apparatus recited in claim 19, wherein the one or more media packets are transmitted via the WPAN link at the time based on the time delay indicated in the delay report received from the second sink device such that the second sink device is configured to receive and render the one or more media packets at the recalculated PTS value.

21. The apparatus recited in claim 20, wherein the one or more media packets transmitted via the WLAN link include the recalculated PTS value to inform the first sink device that the local playback time is to occur at the recalculated PTS value.

22. The apparatus recited in claim 20, wherein the time delay indicated in the delay report received from the second sink device is based on a delay due to buffering, decoding, and rendering at the second sink device.

23. The apparatus recited in claim 19, further comprising:
means for receiving, from a third sink device, a delay report indicating a time delay associated with a WPAN link between the apparatus and the third sink device; and
means for recalculating the PTS value based on a maximum delay among the time delays indicated in the delay reports received from the second sink device and the third sink device.

24. The apparatus recited in claim 19, further comprising:
means for receiving, from the second sink device, a subsequent delay report updating the time delay associated with the WPAN link between the apparatus and the second sink device; and
means for recalculating the PTS value based on the updated time delay indicated in the subsequent delay report received from the second sink device.

25. A non-transitory computer-readable storage medium having computer-executable instructions stored thereon, the computer-executable instructions configured to cause a source device to:
calculate a presentation time stamp (PTS) value indicating a local playback time for one or more media packets to be streamed to a first sink device via a wireless local area network (WLAN) link;
receive a delay report from a second sink device, the delay report indicating a time delay associated with a wireless personal area network (WPAN) link between the source device and the second sink device;
recalculate the PTS value based on the time delay indicated in the delay report received from the second sink device;
transmit the one or more media packets to the first sink device via the WLAN link, wherein the one or more media packets transmitted via the WLAN link include the recalculated PTS value; and
transmit the one or more media packets to the second sink device via the WPAN link, wherein the one or more media packets are transmitted via the WPAN link at a time prior to the recalculated PTS value based on the time delay indicated in the delay report received from the second sink device.

26. The non-transitory computer-readable storage medium recited in claim 25, wherein the one or more media packets are transmitted via the WPAN link at the time based on the time delay indicated in the delay report received from the second sink device such that the second sink device is configured to receive and render the one or more media packets at the recalculated PTS value.

27. The non-transitory computer-readable storage medium recited in claim 26, wherein the one or more media packets transmitted via the WLAN link include the recalculated PTS value to inform the first sink device that the local playback time is to occur at the recalculated PTS value.

28. The non-transitory computer-readable storage medium recited in claim 26, wherein the time delay indicated in the delay report received from the second sink device is based on a delay due to buffering, decoding, and rendering at the second sink device.

29. The non-transitory computer-readable storage medium recited in claim 25, wherein the computer-executable instructions are further configured to cause the source device to:
receive, from a third sink device, a delay report indicating a time delay associated with a WPAN link between the source device and the third sink device; and
recalculate the PTS value based on a maximum delay among the time delays indicated in the delay reports received from the second sink device and the third sink device.

30. The non-transitory computer-readable storage medium recited in claim 25, wherein the computer-executable instructions are further configured to cause the source device to:
receive, from the second sink device, a subsequent delay report updating the time delay associated with the WPAN link between the source device and the second sink device; and
recalculate the PTS value based on the updated time delay indicated in the subsequent delay report received from the second sink device.
